(19) United States
(12) Patent Application Publication
(10) Pub. No.: US 2021/0215401 A1
(43) Pub. Date: Jul. 15, 2021

(54) VORTEX TUBE, VENTILATION SYSTEM AND ELEVATOR

(71) Applicant: KONE Corporation, Helsinki (FI)

(72) Inventors: Ramprasad GOPALA KRISHNAN, Helsinki (FI); Ganesan SELVADURAI, Helsinki (FI)

(73) Assignee: KONE Corporation, Helsinki (FI)

(21) Appl. No.: 17/139,183

(22) Filed: Dec. 31, 2020

(30) Foreign Application Priority Data
Jan. 9, 2020 (EP) 20150996.5

(51) Int. Cl. F25B 9/04; B66B 11/02

(52) U.S. Cl. CPC F25B 9/04; B66B 11/024

(57) ABSTRACT

A vortex tube includes a first end provided with a first outlet; a second end provided with a second outlet; a vortex generating chamber between the first end and the second end; an air inlet leading from a side of the vortex tube into the vortex generating chamber; a first flow passage between the vortex generating chamber and the first outlet; a second flow passage between the first flow passage and the second outlet. The vortex tube includes one or more air guides disposed inside the vortex tube downstream of the vortex generating chamber for increasing laminarity of air flow downstream of the vortex generating chamber. One or more of the air guides is an air guide including plurality of openings, through which openings air can flow. A ventilating system and an elevator are provided for implementing the vortex tube.

### FIELD OF THE INVENTION

The invention relates to a vortex tube, a ventilation system and an elevator, wherein the interior to be ventilated is the interior of a car, a hoistway or a machine room of an elevator, for instance.

### BACKGROUND OF THE INVENTION

Elevators typically have one or more cars traveling vertically in a hoistway. The conditions inside the car are continuously controlled so as to ensure healthy and comfortable experience. This usually involves ventilating the interior with fresh air the temperature of which may be adjustable. Elevator interiors are typically demanding spaces to be ventilated, particularly with regard to efficiency with minimal space consumption, noise level and reliability of the ventilating equipment. The interior of an elevator car for instance, should be ventilated with a simple, lightweighted and compact system so that the car can utilize maximally efficiently its volume as transport space and the moving masses are minimized. The ventilation system should be quiet to ensure good ride comfort, as well as maintained stable and in operation in all situations in order to ensure uninterrupted passenger air supply and comfort. The ventilation system should also be unlikely to malfunction, have low power consumption and it should be quick and easy to install and service.

A drawback of ventilation systems and equipment for elevator use has been that they have not been very compact, efficient and quiet. Vortex tubes, also known as Ranque-Hilsch vortex tubes, utilizing so called vortex tube effect are known components which intake air flow and separate it to two air flows of different temperature, namely to a hot air flow and a cold air flow. Use of a vortex tube as part of a ventilation system arranged to ventilate an interior has been proposed, but found to have room for improvement in terms of as efficiency of the vortex tube to separate the intaken air flow into hot and cold air flows.

### BRIEF DESCRIPTION OF THE INVENTION

The object of the invention is to introduce a new vortex tube, a ventilation system and an elevator. An object is particularly to introduce a solution by which one or more of the above defined problems of prior art and/or problems discussed or implied elsewhere in the description can be solved.

It is brought forward, inter alia, a new vortex tube, a ventilation system and an elevator, which has an improved efficiency (COP) to separate an intaken air flow into hot and cold air flows with a big temperature difference.

It is brought forward a new vortex tube, in particular for a ventilation system, the vortex tube comprising a first end provided with a first outlet; a second end provided with a second outlet; and a vortex generating chamber between the first end and the second end; and an air inlet leading from a side of the vortex tube into the vortex generating chamber for guiding air flow into the vortex generating chamber; and a first flow passage between the vortex generating chamber and the first outlet; and a second flow passage between the first flow passage and the second outlet; wherein the vortex tube is arranged to guide air fed into the air inlet to flow via the air inlet into the vortex generating chamber, and from it into the first flow passage, the vortex tube being arranged to discharge a portion of the air from the vortex tube via the first outlet at the first end, and to guide a portion of the air to flow in the first flow passage back from the first end as backflow; the backflow being arranged to flow into the second flow passage to be discharged from the vortex tube via the second outlet. The vortex tube comprises one or more air guides disposed inside the vortex tube downstream of the vortex generating chamber for increasing laminarity of air flow downstream of the vortex generating chamber, wherein one or more of said air guides is an air guide comprising plurality of openings, through which openings air can flow. With this solution one or more of the above mentioned objects can be achieved. The vortex tube is usable for separating an intaken air flow into hot and cold air flows utilizing a so called vortex tube effect. The one or more air guides, due to being able to substantially increase laminarity of air flow downstream of the vortex generating chamber, increase thermal efficiency of the vortex tube, which is an advantageous effect in many applications, such as a ventilation system of an elevator where efficiency is one important goal, amongst other important goals to be satisfied by the ventilation system such as compactness, lightness, noise level and reliability which are also, at least satisfactorily, facilitated by utilization of a vortex tube.

Preferable further details are introduced in the following, which further details can be combined with the vortex tube individually or in any combination.

In a preferred embodiment, air passing to the air guide is arranged to split into plurality of openings thereof and pass through them to the other side of the air guide.

In a preferred embodiment, the one or more air guides are arranged to reduce Reynolds number of air flow in the vortex tube downstream of the vortex generating chamber to be less than 2000.

In a preferred embodiment, said openings extend parallel to each other through the air guide.

In a preferred embodiment, each said air guide is a perforated plate or a grille.

In a preferred embodiment, each said opening is a through-hole.

In a preferred embodiment, the air guide comprises more than 30 of said openings, preferably more than 50 of said openings. High number of openings facilitates efficiency of reduction of turbulence and thereby increases laminarity of air flow passing through the air guide. The density of said openings is preferably more than 30 of said openings, more preferably more than 50 of said openings per square cm of the cross section of the flow passage wherein the air guide is disposed.

In a preferred embodiment, the air guide fills a complete cross section of a flow passage downstream of the vortex generating chamber.

In a preferred embodiment, each opening has depth/width ratio (d/w) larger than 1, in particular wherein the width (w) is measured in transverse direction of the flow passage and depth (d) in axial direction of the flow passage wherein the air guide in question is disposed.

In a preferred embodiment, the openings extend through the air guide in axial direction of the flow passage wherein the air guide in question is disposed.

In a preferred embodiment, the vortex tube comprises one or more, preferably two, of said air guides disposed in the first flow passage.

In a preferred embodiment, the vortex tube comprises one or more, preferably two, of said air guides disposed in the second flow passage.

In a preferred embodiment, air is guided to swirl in the vortex generating chamber along the inner surface of the vortex generating chamber.

In a preferred embodiment, a hub is inserted in the vortex generating chamber around which air arriving through the air inlet is arranged to swirl in the vortex generating chamber. The hub preferably is formed by a part inserted into the vortex generating chamber. Said part is preferably removably insertable into the vortex generating chamber.

In a preferred embodiment, the second flow passage extends into the vortex generating chamber.

In a preferred embodiment, said air guides disposed in the second flow passage include an air guide or air guides, disposed in a passage of the aforementioned hub, said passage of the aforementioned hub forming a part of the second flow passage. The hub preferably is formed by a part inserted into the vortex generating chamber. Said part is preferably removably insertable into the vortex generating chamber.

In a preferred embodiment, the central hub comprises tangential holes leading from outside the central hub to inside the central hub. The tangential holes in particular converge tangentially with a circular interior of the hub.

In a preferred embodiment, the one or more air guides disposed in the first flow passage are arranged to reduce Reynolds number of air flow in the first flow passage to be less than 2000, in particular at a point, which is located between an air guide and the first opening and/or at a point which is located between an air guide and the vortex generating chamber said point being at the center of the of the cross section of the first flow passage i.e. at a point of the aforementioned backflow.

In a preferred embodiment, it comprises an air valve for controlling discharge of air from the first flow passage through the first outlet, in particular at the first end.

In a preferred embodiment, the air valve comprises a central plug portion for blocking flow of air at the center of the cross section of the first flow passage through the valve, one or more peripheral air passages being formed beside the central plug portion, whereby the air valve is arranged to guide a portion of air through the one or more peripheral air passages for being discharged from the vortex tube via the first outlet, and a portion of the air to flow at the center of the of the cross section of the first flow passage back from the first end as backflow.

In a preferred embodiment, said one or more air guides disposed in the first outlet portion are in the first flow passage between the vortex generating chamber and the valve.

In a preferred embodiment, the hub comprises a central opening, in particular concentric with the vortex generating chamber and the first and second flow passage, for receiving the backflow of air, which backflow returns from the first end inside the first flow passage and flows at the centre of the first flow passage, and for guiding said backflow to flow into the second flow passage.

In a preferred embodiment, the vortex generating chamber has a circular or at least substantially circular cross section.

In a preferred embodiment, the vortex tube comprises phase change material forming one or more of the following:

at least a portion of the inner wall surface of the vortex generating chamber, along which inner wall surface of the vortex generating chamber air is/can be arranged to flow;

at least a portion of the inner wall surface of the first flow passage, along which inner wall surface of the first flow passage air is/can be arranged to flow;

at least portion of the inner wall surface of the second flow passage, along which inner wall surface of the second flow passage air is/can be arranged to flow. Phase changing ability of the material enhances ability of the material to absorb energy. The advantage of the phase change material is that enhances energy transfer within the vortex tube so that COP value (coefficient of performance) of the vortex tube increases. By use of PCM excessive thermal losses of the vortex tube are also avoided. Phase change material facilitates one or more of these objects and advantages also if the air guides are different in structure or differently positioned than described above, or even absent completely. Accordingly, the vortex tube comprising phase change material as defined above can form an invention independent on features related to the air guides.

In a preferred embodiment, the vortex tube comprises one or more body parts coated internally with a phase change material, the thickness of the coating preferably being 0.5-1.0 mm.

In a preferred embodiment, the aforementioned phase change material is solid-solid-phase change material.

In a preferred embodiment, the aforementioned phase change material comprises salt hydrates (MxNyH2O).

In a preferred embodiment, the internal diameter of the first flow passage is between 5 and 15 mm, more preferably between 5 and 10 mm. Preferably, moreover, a length L of the vortex tube is between 100 and 200 mm, more preferably between 120 and 150 mm wherein the length is the distance in axial direction x between the second outlet and the one or more peripheral air passages. The ratio length L/internal diameter of the first flow passage is preferably between 10 and 30, preferably between 15 and 20, such as 17-18.

In a preferred embodiment, air is guided to pass in the first flow passage towards the first end along the inner surface of the first flow passage, in particular swirling, and back from the first end as backflow towards the second end at the center of the of the cross section of first flow passage.

It is also brought forward a new ventilation system arranged to ventilate an interior the ventilation system comprising an air supply duct; and a device for feeding air into the air supply duct; and a vortex tube as defined anywhere above, wherein a first outlet duct is connected to the first outlet opening and the interior for guiding air from the first outlet opening to the interior and/or a second outlet duct is connected to the second outlet opening and the interior for guiding air from the second outlet opening to the interior. With this solution one or more of the above mentioned objects can be achieved such that air, or at least part of it, which air exits a vortex tube is usable for heating and/or cooling the interior to be ventilated.

Preferable further details of the ventilation system have been introduced earlier above as well as in the following, which further details can be combined with the ventilation system individually or in any combination.

In a preferred embodiment, the first outlet duct is connected to the interior to be ventilated via an air distribution device comprising one or more openings through which air from the first outlet duct can flow into the interior to be ventilated.

In a preferred embodiment, the second outlet duct is connected to the interior to be ventilated via an air distribution device comprising one or more openings through which air from the second outlet duct can flow into the interior to be ventilated.

In a preferred embodiment, the ventilation system comprises a valve, preferably for example in one of said first and second outlet duct, for controlling air flow between the vortex tube and the interior to be ventilated.

In a preferred embodiment, the valve is connected to a thermostat. The thermostat preferably is arranged to sense temperature of the interior to be ventilated or the temperature of air to be guided therein. The thermostat then preferably comprises a sensor head located in the interior to be ventilated or in a location via which air is guided to the interior to be ventilated. The valve is particularly controllable by the thermostat.

In a preferred embodiment, a branch duct is connected to the valve and the valve is arranged to adjust how big proportion of the flow from the vortex tube flows into the branch duct.

In a preferred embodiment, the aforementioned branch duct leads to a space outside the interior to be ventilated.

In a preferred embodiment, the air supply duct is connected to the air inlet of the vortex tube.

In a preferred embodiment, the aforementioned device for feeding air into the air supply duct arranged to feed pressurized air into the air supply duct. It is preferably arranged to intake air and elevate its pressure.

In a preferred embodiment, the aforementioned device for feeding air into the air supply duct is an air compressor.

In a preferred embodiment, the aforementioned device for feeding air into the air supply duct is arranged to intake air from a source outside the interior to be ventilated, such as hoistway, the ventilation system of the building, or exterior of the building, for instance.

It is also brought forward a new elevator comprising an interior to be ventilated and a ventilation system as defined anywhere above arranged to ventilate said interior. With this solution one or more of the above mentioned objects can be achieved. A ventilation system utilizing the vortex tube is advantageous particularly in context of an elevator where compactness, lightness, efficiency, reliability and small amount of noise are important properties of a ventilation system.

Preferable further details of the elevator have been introduced earlier above as well as in the following, which further details can be combined with the elevator individually or in any combination.

In a preferred embodiment, the elevator comprises an elevator car arranged to be moved vertically in a hoistway between vertically displaced landings.

In a preferred embodiment, the interior to be ventilated is the interior of an elevator car of the elevator, a machine room of the elevator, a hoistway of the elevator or a control cabinet of the elevator.

In a preferred embodiment, the elevator is a passenger elevator comprising an elevator car comprising said interior to be ventilated. The interior is preferably closable by a door. In this kind of context use of the ventilation system as defined in particularly advantageous.

### BRIEF DESCRIPTION OF THE DRAWINGS

In the following, the present invention will be described in more detail by way of example and with reference to the attached drawings, in which

FIG. 1a illustrates an embodiment a vortex tube.

FIG. 1b illustrates a cross section A-A of the vortex tube of FIG. 1.

FIG. 2a illustrates a first preferred embodiment of the air guide of FIG. 1 and its position in the vortex tube as viewed in axial direction of the vortex tube.

FIG. 2b illustrates a side view of the air guide of FIG. 2a.

FIG. 3a illustrates a second preferred embodiment of the air guide of FIG. 1 and its position in the vortex tube as viewed in axial direction of the vortex tube.

FIG. 3b illustrates a side view of the air guide of FIG. 3a.

FIG. 4 illustrates an embodiment of a ventilation system comprising a vortex tube as illustrated in FIG. 1.

FIG. 5 illustrates an embodiment of an elevator comprising a ventilation system as illustrated in FIG. 4.

The foregoing aspects, features and advantages of the invention will be apparent from the drawings and the detailed description related thereto.

### DETAILED DESCRIPTION

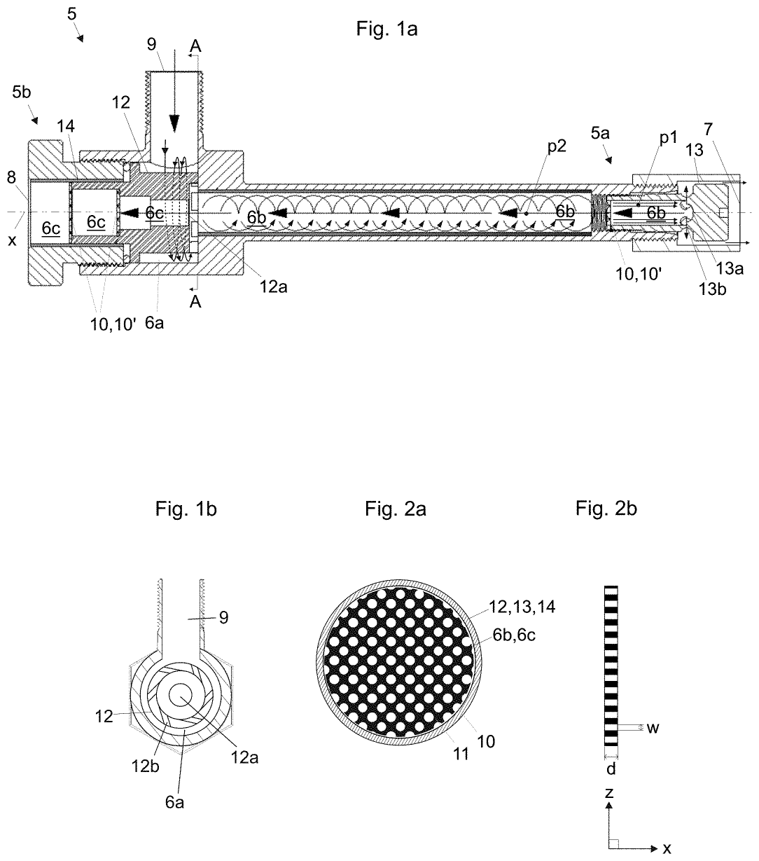

FIG. 1 illustrates an embodiment a vortex tube 5 comprising a first end 5a provided with a first outlet 7 and a second end 5b provided with a second outlet 8. The vortex tube 5 comprises a vortex generating chamber (6a) between the first end and the second end 5a,5b, and between the aforementioned outlets 7, 8 provided in said ends 5a,5b. The vortex tube 5 moreover comprises an air inlet 9 leading from a side of the vortex tube 5 into the vortex generating chamber 6a for guiding air flow into the vortex generating chamber 6c and a first flow passage 6b between the vortex generating chamber 6a and the first outlet 7 as well as a second flow passage 6c between the first flow passage 6b and the second outlet 8.

The vortex tube 5 is arranged to guide air fed into the air inlet 9 to flow via the air inlet 9 into the vortex generating chamber 6a, and from it into the first flow passage 6b, the vortex tube 5 being arranged to discharge a portion of the air from the vortex tube 5 via the first outlet 7 at the first end 5a, and to guide a portion of the air to flow in the first flow passage 6b back from the first end 5a as backflow; the backflow being arranged to flow into the second flow passage 6c to be discharged from the vortex tube 5 via the second outlet 8.

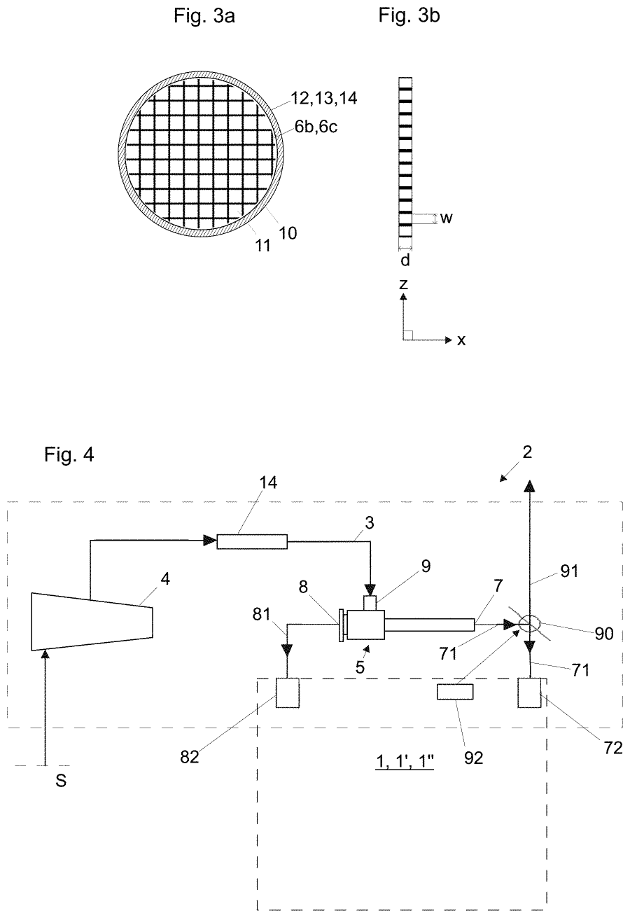

The vortex tube 5 comprises one or more air guides 10,10′ disposed inside the vortex tube 5 downstream of the vortex generating chamber 6c, in particular in the first flow passage 6b and/or in the second flow passage 6c for increasing laminarity of air flow downstream of the vortex generating chamber 6c, in particular for reducing Reynolds number of the air flow. Each said air guide 10,10′ is an air guide 10,10′ comprising plurality of openings 11,11′, through which openings 11,11′ air can flow. A first preferred embodiment of the air guide 10 is illustrated in FIGS. 2a and 2b and a second preferred embodiment of the air guide 10′ is illustrated in FIGS. 3a and 3b. As illustrated in FIGS. 1,2a and 3a, the air guide 10,10′ preferably fills the complete cross section of a flow passage 6b,6c downstream of the vortex generating chamber 6c.

Each said flow passage 6b,6c has an axial direction x. The openings 11,11′ extend through the air guide 10,10′ in axial direction x of the flow passage 6b,6c wherein the air guide 10,10′ in question is disposed.

Air passing to the air guide 10,10′ is arranged to split into plurality of openings 11,11′ thereof and pass through them to the other side of the air guide 10,10′. The guide 10,10′ is such that said openings 11,11′ extend parallel to each other through the air guide 10,10′.

In the preferred embodiment of FIG. 2, said air guide 10 is a perforated plate. In this case, each said opening 11 is a through-hole preferably punched or drilled in a plate, such as a metal or plastic plate or composite material plate. The perforated plate can alternatively be made by molding.

In the preferred embodiment of FIG. 3, said air guide 10′ is a grille. In this case, preferably each said opening 11 is a through-hole bordered by bars.

In the preferred embodiments of FIGS. 2 and 3 each opening has depth/width ratio d/w greater than 1, wherein the width w is measured in transverse z direction of the flow passage and depth d in axial direction x of the flow passage 6b,6c wherein the air guide 10,10′ in question is disposed. This facilitates efficiency of reduction of turbulence and thereby increases laminarity of air flow passing through the air guide 10,10′. In the preferred embodiments illustrated, said axial direction x of the flow passages 6a and 6b equals the axial direction x of the vortex tube 5.

Preferably, the number of said openings 11,11′ is great. Particularly, preferably the air guide 10,10′ comprises more than 30 of said openings 11,11′ preferably more than 50 of said openings. This facilitates efficiency of reduction of turbulence and thereby increases laminarity of air flow passing through the air guide 10,10′. The density of said openings is preferably more than 30 of said openings 11,11′, more preferably more than 50 of said openings 11,11′ per square cm of the cross section of the flow passage 6b,6c wherein the air guide 10,10 is disposed.

In the preferred embodiment illustrated in FIG. 1, the vortex tube 5 comprises two of said air guides 10,10′ disposed in the first flow passage 6b. This facilitates efficiency of reduction of turbulence and thereby increases laminarity of air flow passing in the first flow passage 6b.

In the preferred embodiment illustrated in FIG. 1, the vortex tube 5 comprises two of said air guides 10,10′ disposed in the second flow passage 6c. This facilitates efficiency of reduction of turbulence and thereby increases laminarity of air flow passing in the second flow passage 6c. A laminar flow is characterized by the parallel flow of fluid layers. This parallel flow between layers can be increased by reducing the disruption between layers.

In the preferred embodiment illustrated in FIG. 1, the one or more air guides 10,10′ are arranged to reduce Reynolds number of air flow in the vortex tube downstream of the vortex generating chamber 6c to be less than 2000. More specifically, the one or more air guides 10,10′ disposed in the first flow passage 6b are arranged to reduce Reynolds number of air flow in the first flow passage 6b to be less than 2000, in particular at a point p1, which is located between an air guide 10,10′ and the first opening 7 and/or at a point p2 which is located between an air guide 10,10′ and the vortex generating chamber 6c said point p2 being at the center of the of the cross section of first flow passage 6b i.e. at a point of the aforementioned backflow.

The vortex tube 5 functions so that air is guided to swirl in the vortex generating chamber 6a along the inner surface of the vortex generating chamber 6a.

For facilitating separation of air flow arriving from the vortex generating chamber 6a to the first end 5a to a portion (hot portion) to exit the vortex tube 5 via the first outlet 7 and a portion (cold portion) to exit the vortex tube 5 via the second opening 8, the vortex tube 5 comprises at the first end 5a thereof an air valve 13 for controlling discharge of air from the first flow passage 6b through the first outlet 7. The air valve 13 comprises a central plug portion 13a for blocking flow of air flow at the center of the cross section of the first flow passage 6b through the valve 13. One or more peripheral air passages 13b are formed beside the central plug portion 13a, whereby the air valve 13 is arranged to guide a portion (hot portion) of air through the one or more peripheral air passages 13b for being discharged from the vortex tube 5 via the first outlet 7, as well as to guide a portion (cold portion) of the air to flow at the center of the of the cross section of first flow passage 6b back from the first end 5a as backflow. Said one or more air guides disposed in the first outlet portion 6a are in the first flow passage 6b between the vortex generating chamber 6a and the valve 13.

The separation is meant to work such that when the air comes at the point of the plug portion 13a, portion of it is forced to reverse directions, which requires a change in diameter to the flow route of the air. The original vortex must decrease in diameter, and in order to do so, it must give off energy. This energy is shed in the form of heat. The reversed portion of the air is directed out of the vortex tube 5 with a drastically reduced temperature via the second opening at the second end 5b, also referred to as “the cold end”. Another portion of the air escapes through the first opening 7 in the first end 5a, also referred to as “the hot end” of the vortex tube 5, resulting in a hot airflow at the first end 5a, and a hot airflow at the second end 5b of the vortex tube 5.

For facilitating said swirl in the vortex generating chamber 6a, a hub 12 is inserted in the vortex generating chamber 6a around which air arriving through the air inlet 9 is arranged to swirl in the vortex generating chamber 6a.

The hub 12 comprises a central opening 12a, in particular concentric with the vortex generating chamber 6a and the first and second flow passage 6b;6c, for receiving the aforementioned backflow of air, which backflow returns from the first end 5a inside the first flow passage 6b and flows at the centre of the first flow passage 6b, and for guiding said backflow to flow into the second flow passage 6c.

FIG. 1b illustrates a sectional view A-A of the vortex tube 5 as viewed in axial direction x. The central hub 12 comprises tangential holes 12b leading from outside the central hub 12 to inside the central hub 12, and into the first flow passage 6b. The tangential holes 12b converge tangentially with a circular interior of the hub 12. Thereby, the air will continue to swirl along the inner face of the interior of the central hub 12 and around the backflow moving towards the second end 5b thereby allowing it to flow through the vortex and into the opening 12a.

In the preferred embodiment of FIG. 1, the hub 12 comprises a passage forming a part of the second flow passage 6c. In the preferred embodiment of FIG. 1, an air guide, more specifically two air guides 10,10′, disposed in the second flow passage 6c are disposed particularly in the passage of the hub 12 forming part of the second flow passage 6c, wherein the hub is formed by a part inserted into the vortex generating chamber 6a.

Generally preferably, the vortex generating chamber 6a preferably has a circular or at least substantially circular cross section for facilitating said swirl.

The vortex tube 5 comprises phase change material 14 forming the inner wall surface of the first flow passage 6c, along which inner wall surface of the first flow passage 6b air is arranged, or at least can be arranged, to flow.

The vortex tube 5 comprises phase change material 14 forming the inner wall surface of the second flow passage 6c, along which inner wall surface of the second flow passage 6c air is arranged, or at least can be arranged, to flow.

Additionally, or alternatively the vortex tube 5 could comprises phase change material (PCM) 14 forming the inner wall surface of the vortex generating chamber 6a, along which inner wall surface of the vortex generating chamber 6a air is arranged, or at least can be arranged, to flow.

Phase changing ability of the material enhances ability of the material to absorb energy. The advantage of the phase change material 14 is that it enhances energy transfer within the vortex tube 5 so that COP of the vortex tube 5 increases. Inter alia, the phase change material 14, particularly in the inner wall surface of the first flow passage 6c, absorbs thermal energy without major pressure difference and enhances the capacity to receive more energy to the air flow moving towards the first end 5a of the vortex tube 5 and thus increases cooling of the aforementioned backflow moving towards the second end 5b. Generally, by use of PCM excessive thermal losses of the vortex tube are avoided. Phase change material facilitates these objects and advantages also if the air guides are different in structure or differently positioned than described above, or even absent completely.

The phase change material 14 is included into the vortex tube 5 as internal coating, more specifically such that the vortex tube 5 comprises one or more body parts coated internally with a phase change material, the thickness of the coating preferably being 0.5-1.0 mm.

Said phase change material is preferably solid-solid-phase change material. Preferably, the phase change material comprises salt hydrates MxNyH2O.

FIG. 4 illustrates an embodiment of a ventilation system 2 implementing the vortex tube 5 as described referring to FIGS. 1-3b. The ventilation system 2 is arranged to ventilate an interior 1,1′,1″ and comprises an air supply duct 3; and a device 4 suitable for and arranged to feed air into the air supply duct 3; and a vortex tube 5 as described referring to FIGS. 1-3b. The air supply duct 3 is connected to the air inlet 9 of the vortex tube 5.

The vortex tube 5 is advantageous to be utilized particularly in context of an elevator where efficiency is one important goal, amongst other important goals to be satisfied by the ventilation system such as compactness, lightness, noise level and reliability which are also, at least satisfactorily, facilitated by utilization of the vortex tube 5.

The one or more air guides, due to being able to substantially increase laminarity of air flow downstream of the vortex generating chamber, advantageously increase thermal efficiency of the vortex tube 5.

As mentioned, the vortex tube preferably comprises phase change material. The advantage of the phase change material 14 is that it enhances energy transfer within the vortex tube so that COP of the vortex tube increases. PCM also reduces thermal losses.

The ventilation system comprises a first outlet duct 71 connected to the first outlet opening 7 and the interior 1,1′,1″ for guiding air from the first outlet opening 7 to the interior 1,1′,1″ and a second outlet duct 81 connected to the second outlet opening 8 and the interior 1,1′,1″ for guiding air from the second outlet opening 8 to the interior 1,1′,1″. Hereby, the air, or at least part of it, which air exits the vortex tube via the first opening and the second opening, is usable for adjusting temperature of the interior to be ventilated.

The first outlet duct 71 is connected to the interior 1,1′,1″ to be ventilated via an air distribution device 72 comprising one or more openings through which air from the first outlet duct can flow into the interior 1,1′,1″. The air distribution device 72 may be mounted on the ceiling, wall or floor of the interior 1,1′,1″, for example.

The second outlet duct 81 is connected to the interior 1,1′,1″ to be ventilated via an air distribution device 82 comprising one or more openings through which air from the first outlet duct can flow into the interior 1,1′,1″. The air distribution device 82 may be mounted on the ceiling, wall or floor of the interior 1,1′,1″, for example. The air distribution device 72 via which the first outlet duct 71 is connected to the interior to be ventilated can also be the same (or different, as illustrated) air distribution device 82 via which the second outlet duct 81 is connected to the interior to be ventilated.

In the preferred embodiment of FIG. 4, the ventilation system 2 moreover comprises a valve 90 in one of said first and second outlet duct 71,81 for controlling air flow between the vortex tube 5 and the interior 1,1′,1″. The valve 90 is preferably connected to a thermostat 92, and controllable by the thermostat 92. The valve could also be positioned in a different position such as in unity of an air distribution device 72,82.

The thermostat is arranged to sense temperature of the interior to be ventilated, but alternatively it could be arranged to sense temperature of the air to be guided into said interior. The thermostat then is located or at least comprises a sensor head located in the interior to be ventilated. In said alternative where the thermostat is arranged to sense temperature of the air to be guided into said interior, the thermostat can be located or at least comprise a sensor head located in a location via which air is guided to the interior to be ventilated.

In the preferred embodiment of FIG. 4, the ventilation system 2 moreover comprises a branch duct 91 connected to the valve 92 and the valve 92 is arranged to adjust how big proportion of the flow from the vortex tube flows into the branch duct 91.

In the preferred embodiment of FIG. 4, the branch duct 91 leads to a space outside the interior to be ventilated 1,1′,1″.

In the preferred embodiment of FIG. 4, the device 4 for feeding air into the air supply duct 3 is an air compressor. The air supply duct 3 can comprise a filter 14 for filtering the air to be supplied to the vortex tube.

In the preferred embodiment of FIG. 4, the device (4) for feeding air into the air supply duct 3 is arranged to intake air from a source S outside the interior 1,1′,1″ to be ventilated.

In a preferred embodiment of an elevator, the elevator comprises an interior 1,1′,1″ and a ventilation system 2 as described referring to FIG. 4 arranged to ventilate said interior 1,1′,1″.

Generally, when the interior to be ventilated is the interior 1 of the elevator car C, the source S outside the interior 1 to be ventilated is preferably the hoistway 1″ wherein the car C is arranged to be moved vertically.

Generally, when the interior to be ventilated is the interior 1′ of the machine room of the elevator (i.e. the space above or adjacent the hoistway where hoisting machine M is mounted), the source S outside the interior 1′ to be ventilated is preferably a ventilation system of the building wherein the elevator is installed, or exterior the building.

Generally, when the interior to be ventilated is the interior 1″ of the hoistway of the elevator, the source S outside the interior 1′ to be ventilated is preferably a ventilation system of the building wherein the elevator is installed, or exterior the building.

Generally, the interior to be ventilated can be any interior, such as an interior of a control cabinet of the elevator. The cabinet is then preferably a cabinet that encases an electronic control system of the elevator for controlling the hoisting machinery, such as inter alia the motor, of the elevator.

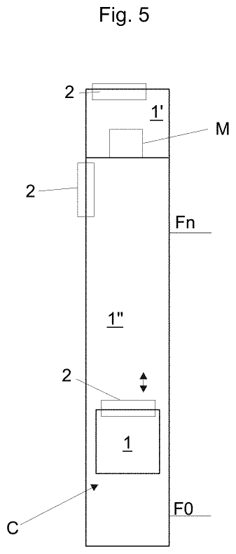

FIG. 5 illustrates an embodiment of the elevator with three alternative options of the interior 1,1′,1″ to be ventilated. Namely, the interior 1,1′,1″ to be ventilated is the interior of an elevator car 1 or a machine room 1′ or a hoistway 1″ of the elevator.

The elevator comprises an elevator car C arranged to be moved vertically in a hoistway 1″ between vertically displaced landings F0,Fn. The elevator moreover comprises a hoisting machine M for moving the car C. The hoisting machine M comprises preferably a motor (not showed) arranged to rotate a drive sheave (not showed) around which a hoisting roping (not showed) connected with the car C passes. The hoisting function could alternatively be arranged with some other way, such as in any way known from prior art, for example.

In FIG. 5, the elevator moreover a machine room (i.e. the space above or adjacent the hoistway 1″ where the hoisting machine M of the elevator is mounted. A machine room separate from the hoistway is however not necessary since machineroomless elevators are known to exist.

As for the size of the vortex tube, it is preferable, particularly in elevator use, that the internal diameter of the first flow passage 6b is between 5 and 15 mm, more preferably between 5 and 10 mm. A length L of the vortex tube 5 is preferably between 100 and 200 mm, more preferably between 120 and 150 mm wherein the length is the distance in axial direction x between the outlet 8 and the one or more peripheral air passages 13b. The ratio length L/internal diameter of the first flow passage 6b is preferably between 10 and 30, preferably between 12 and 20, such as 17-18. The above dimension ranges each, but most efficiently in combination producing the defined L/D range, facilitate that kinetic energy losses are minimized, energy separation is increased, energy destruction decreases and temperature difference increases, with optimized L/D, mixing of the cold and hot streams reduced or avoided, the performance is increased.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims.

1. A vortex tube comprising:
a first end provided with a first outlet;
a second end provided with a second outlet;
a vortex generating chamber between the first end and the second end;
an air inlet leading from a side of the vortex tube into the vortex generating chamber;
a first flow passage between the vortex generating chamber and the first outlet; and
a second flow passage between the first flow passage and the second outlet,
wherein the vortex tube is arranged to guide air fed into the air inlet to flow via the air inlet into the vortex generating chamber, and from the vortex generating chamber into the first flow passage, the vortex tube being arranged to discharge a portion of the air from the vortex tube via the first outlet at the first end, and to guide a portion of the air to flow in the first flow passage back from the first end as backflow, the backflow being arranged to flow into the second flow passage to be discharged from the vortex tube via the second outlet, and
wherein the vortex tube comprises one or more air guides disposed inside the vortex tube downstream of the vortex generating chamber for increasing laminarity of air flow downstream of the vortex generating chamber, wherein one or more of said air guides is an air guide comprising a plurality of openings, through which openings air can flow.

2. The vortex tube according to claim 1, wherein the air passing to the air guide is arranged to split into the plurality of openings thereof and pass through the plurality of openings to the other side of the air guide.

3. The vortex tube according to claim 1, wherein the one or more air guides are arranged to reduce Reynolds number of air flow in the vortex tube downstream of the vortex generating chamber to be less than 2000.

4. The vortex tube according to claim 1, wherein each said air guide is a perforated plate or a grille.

5. The vortex tube according to claim 1, wherein the air guide comprises more than 30 of said openings.

6. The vortex tube according to claim 1, wherein each opening has a depth/width ratio (d/w) greater than 1.

7. The vortex tube according to claim 1, wherein the openings extend through the air guide in an axial direction of the flow passage wherein the air guide in question is disposed.

8. The vortex tube according to claim 1, wherein the vortex tube comprises one or more of said air guides disposed in the first flow passage.

9. The vortex tube according to claim 1, wherein the vortex tube comprises one or more of said air guides disposed in the second flow passage.

10. The vortex tube according to claim 1, wherein one or more air guides disposed in the first flow passage are arranged to reduce Reynolds number of air flow in the first flow passage to be less than 2000, at a point located between an air guide and the first opening and/or at a point located between an air guide and the vortex generating chamber said point located between the air guide and the vortex generating chamber being at a center of the cross section of the first flow passage.

11. The vortex tube according to claim 1, wherein air is guided to swirl in the vortex generating chamber along the inner surface of the vortex generating chamber.

12. The vortex tube according to claim 1, wherein a hub is inserted in the vortex generating chamber, around which air arriving through the air inlet is arranged to swirl in the vortex generating chamber.

13. The vortex tube according to claim 1, further comprising an air valve for controlling discharge of air from the first flow passage through the first outlet.

14. The vortex tube according to claim 1, wherein the air valve comprises a central plug portion for blocking flow of air at a center of the cross section of the first flow passage through the valve, one or more peripheral air passages being formed beside the central plug portion, whereby the air valve is arranged to guide a portion of air through the one or more peripheral air passages for being discharged from the vortex tube via the first outlet and a portion of the air to flow at the center of the of the cross section of the first flow passage back from the first end as backflow.

15. The vortex tube according to claim 1, wherein the hub comprises a central opening for receiving the backflow of air, which backflow returns from the first end inside the first flow passage and flows at the center of the first flow passage, and for guiding said backflow to flow into the second flow passage.

16. The vortex tube according to claim 1, wherein the vortex tube comprises phase change material forming one or more of the following:
at least a portion of the inner wall surface of the vortex generating chamber, along which inner wall surface of the vortex generating chamber air is/can be arranged to flow;
at least a portion of the inner wall surface of the first flow passage, along which inner wall surface of the first flow passage air is/can be arranged to flow;
at least a portion of the inner wall surface of the second flow passage, along which inner wall surface of the second flow passage air is/can be arranged to flow.

17. A ventilation system arranged to ventilate an interior comprising:
an air supply duct;
a device for feeding air into the air supply duct;
the vortex tube according to claim 1; and
a first outlet duct connected to the first outlet opening and the interior for guiding air from the first outlet opening to the interior and/or a second outlet duct connected to the second outlet opening and the interior for guiding air from the second outlet opening to the interior.

18. An elevator comprising:
an interior; and
the ventilation system according to claim 17 arranged to ventilate said interior.

19. The vortex tube according to claim 2, wherein the one or more air guides are arranged to reduce Reynolds number of air flow in the vortex tube downstream of the vortex generating chamber to be less than 2000.

20. The vortex tube according to claim 2, wherein each said air guide is a perforated plate or a grille.
